(19) United States
(12) Patent Application Publication
(10) Pub. No.: US 2018/0252741 A1
(43) Pub. Date: Sep. 6, 2018

(54) METHOD AND DEVICE FOR DETERMINING MACHINE SPEEDS

(71) Applicant: Prüftechnik Dieter Busch AG, Ismaning (DE)

(72) Inventors: Dietrich Brunn, Unterföhring (DE); Jan Germer, München (DE)

(73) Assignee: Prüftechnik Dieter Busch AG, Ismaning (DE)

(21) Appl. No.: 15/905,045

(22) Filed: Feb. 26, 2018

(30) Foreign Application Priority Data
Mar. 1, 2017 (DE) 10 2017 104 207.5

(51) Int. Cl. G01P 3/48; G01H 13/00

(52) U.S. Cl. CPC G01P 3/4802; G01H 13/00

(57) ABSTRACT

The method provides determining at least one speed of a machine, wherein, on the basis of the measurement of a vibration variable carried out on the machine over time, the complex spectrum of this variable is determined, wherein a frequency interpolation is carried out; boundary conditions are established for the evaluation of the spectrum, which include the permissible frequency range of an expected main speed, a set of relative frequencies with respect to the main speed in the form of frequency multipliers, and a weighting factor for the particular relative frequency; a spectral probability density is calculated with consideration for the boundary conditions, which results for each frequency of the permissible frequency range as a sum of the amplitude of the spectrum, which has been weighted with the particular weighting factor and the main speed is determined on the basis of the frequency having the maximum probability density.

### BACKGROUND OF THE INVENTION

The invention relates to a method and a device for determining machine speeds on the basis of vibration measurements carried out on the machine.

One possibility for determining machine speeds is to detect at least one vibration variable, such as, for example, deflection, speed, or acceleration, as a function of time by a sensor on the machine and to determine this vibration variable by a suitable spectral transformation thereof, wherein the spectrum consisting of a real part and an imaginary part is then evaluated, typically with consideration for certain boundary conditions, in order to determine or estimate the machine speed.

Document U.S. Pat. No. 6,087,796 A describes a method in which, in the evaluation of the power density spectrum, local maxima are identified in a predefined frequency range and, for each identified local maximum, a probability is calculated that this is the machine rotational frequency. The machine is an induction motor in this case, wherein, in addition to the vibration measurement, flux measurements are also carried out and local maxima in the flux spectrum are determined and are compared with the local maxima of the vibration measurement, in order to evaluate the local maxima of the vibration measurement.

US 2007/0032966 A1 relates to an example for determining rotational speed, wherein not only the vibration spectrum but also phase relationships of various vibration components are taken into account.

U.S. Pat. No. 5,744,723 A relates to a method for determining rotational speed, wherein the vibration spectrum detected by a vibration measurement is compared with a reference vibration spectrum for a known speed and a stretch factor is determined from the comparison of the two spectra, on the basis of which the rotational speed is determined.

GB 2466472 A relates to a method for determining rotational speed on an induction motor, wherein the vibration spectrum is scanned for pairs of local maxima which result from the rotational frequency or the motor supply frequency, wherein higher harmonics are also taken into account.

U.S. Pat. No. 5,530,343 A relates to an apparatus for determining the speed of an induction motor, wherein the magnetic flux is measured. By comparing groups of peaks in the corresponding frequency spectra, the speed of the motor is calculated.

### SUMMARY OF THE INVENTION

The problem addressed by the present invention is that of providing a method and a device for determining machine speeds, wherein a particularly reliable determination of the main speed of the machine is to be made possible.

This problem is solved by a method and by a system according to the present invention.

In the invention, a particularly reliable determination of the main speed of the machine is made possible in particular by the following measures: On the one hand, in contrast to the standard methods which are based on the calculation of frequency-discrete spectra by the FFT or the DFT, the underlying frequency-continuous spectrum can be approximated, with an accuracy which is freely selectable, in principle, by frequency interpolation, for example by oversampling or frequency shifting. On the other hand, based on this spectrum, the main speed is determined on the basis of the frequency at which a spectral probability density, which has been calculated with consideration for boundary conditions, becomes maximum, wherein the boundary conditions include the permissible frequency range of the expected main speed, a set of relative frequencies with respect to the main speed in the form of frequency multipliers, and a weighting factor for the particular relative frequency. The probability density results for each frequency of the permissible frequency range as the sum of the amplitude of the spectrum, which has been weighted with the particular weighting factor, at the frequency multiplied by the particular frequency multiplier.

The relative frequencies are typically higher harmonics of the main speed. Preferably, the spectrum is determined in the frequency range by oversampling, for example, an at least 8-fold oversampling.

The reliability of the speed determination can be increased by determining a set of potential main speeds by iteratively carrying out the calculation of the probability density and the determination of the main speed on the basis of the maximum of the probability density by removing from the present spectrum the components of the most recently determined main speed and its relative frequencies, in order to produce a corrected spectrum which is used as the basis for the next iteration, in which a new potential main speed is determined on the basis of the maximum of a new probability density which is calculated on the basis of the corrected spectrum.

Preferably, for each of the determined potential main speeds, a trust probability is determined that this is the sought machine speed, wherein the trust probability of a potential main speed results from the difference, which has been integrated over all frequencies of the permissible frequency range, of the probability density utilized in the determination of the particular potential main speed and the probability density utilized in the next iteration, i.e., a difference of the cumulative probabilities is taken into account.

Preferably, a trust value is provided for each of the determined potential main speeds, which results from the trust probability, divided by the difference, which has been integrated over all frequencies of the permissible frequency range, between the probability density utilized in the first iteration and the probability density calculated on the basis of the corrected spectrum obtained in the last iteration, i.e., the trust value is a normalized trust probability, wherein the difference between the uncorrected spectrum and the noise of the spectrum is essentially incorporated into the normalization.

For example, a trust value of at least 70% can be required in order to accept the associated potential main speed as the machine speed.

Further preferred embodiments of the invention are discussed in detail below.

### BRIEF DESCRIPTION OF THE DRAWING FIGURES

Embodiments of the invention are explained in greater detail in the following, by way of example, with reference to the attached drawings. In the drawings:

FIG. 1 shows a schematic representation of one example of a system for determining machine speeds;

FIGS. 2a and 2b show one example of a vibration spectrum measured on a machine as well as the associated probability density determined from the first three higher harmonics of the rotational frequency, wherein the range about the main speed is shown in an enlarged view in FIG. 2b; and

FIG. 3 shows a vibration spectrum measured on a machine (top), the corrected spectrum obtained after six iterations (middle), and the probability densities obtained per iteration (bottom).

### DESCRIPTION OF THE INVENTION

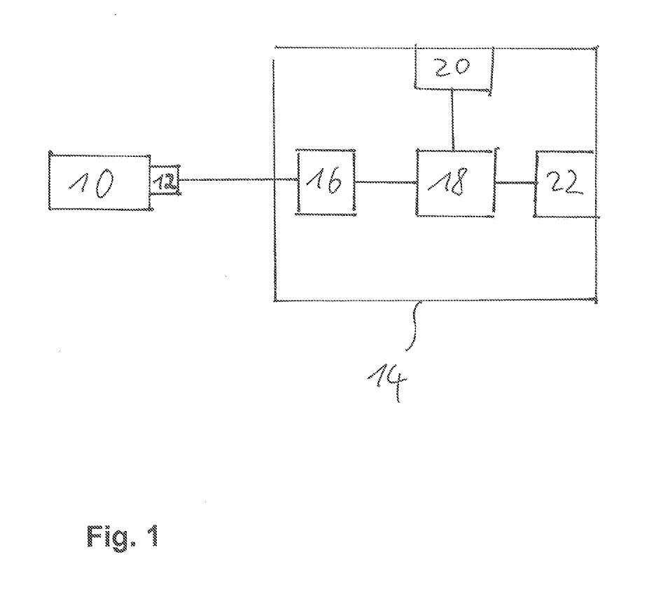

FIG. 1 schematically shows one example of a system for determining machine speeds, wherein a machine 10 is provided with a vibration sensor 12 which measures a vibration variable, for example speed or acceleration, on the machine 10 over time. The sensor 12 is connected to an evaluation device 14 which determines the machine speed on the basis of the signal from the sensor 12. The evaluation device 14 comprises a unit 16 for transforming the time signal from the sensor 12 into the frequency range, in order to obtain the complex spectrum of the vibration variable, a unit 18 for evaluating the spectrum, an input unit 20, by which, for example, boundary conditions for the evaluation of the spectrum can be input, and an output unit 22 for outputting the result of the spectral evaluation.

A vibration measurement carried out by the sensor 12 yields a band-limited, discrete time signal having a certain length, which was scanned with a scanning frequency and on the basis of which a discrete spectrum is obtained by a fast Fourier transform (FFT). This is a discretized version of the Fourier transform

X(f)= [symbol] {x(t)}:=∫_{-∞}^{∞}x(t)e^{-12πft}dt

of the time signal x(t). In order to avoid, to the greatest extent possible, artifacts resulting from the discretization, a frequency interpolation via oversampling in the frequency range is utilized, wherein the oversampling is preferably at least eight-fold. Such an oversampling is achieved by interpolation using a suitable kernel, i.e.,

\tilde{X}(f)= [symbol] {x(t)}≠ [symbol] {w_{A}(t)}

It is efficiently achieved in this method via augmentation with zeros on the time signal and a subsequent Fourier transform. The frequency resolution of a k-fold oversampling results, in this case, from

$$Δ f = \frac{1}{T \cdot ( 1 + k )}$$

wherein T is the sampling interval. In vibration spectra, it is typical not only for a main frequency f₀ corresponding to the speed to appear, but also for multiple additional local maxima to occur, which are typically in the form of whole-number multiples of f₀ (“higher harmonics”). Further speed-dependent components can also appear, however, which are not higher harmonics, i.e., are in the form of non-whole-number multiples of the main frequency, for example, tooth engagement frequencies in the case of gears. Therefore, the accuracy of the determination of the main frequency on the basis of the spectrum can be increased by also including the speed-dependent components in the determination of the main frequency.

This can be achieved by establishing, in a suitable way, a set of relative frequencies based on the main speed in the form of frequency multipliers r₁, . . . , rₙ, and a set of weighting factors w₁, . . . , wₙ for the relative frequencies; in this case, a weighting factor w₀ for the main frequency f₀ (frequency multiplier r₀=1) is also established.

r={1, r₁, . . . , rₙ}

w={w₀, w₁, . . . , wₙ}

Furthermore, a frequency range of the expected main frequency is established (for example, expected main frequency f₀±10%). Next, a spectral probability density P(f) is calculated with consideration for these boundary conditions, which results for each frequency of the permissible frequency range as a sum of the amplitude of the spectrum, which has been weighted with the particular weighting factor, at the frequency multiplied by the particular frequency multiplier.

$$P ( f ) = \frac{1}{C} {\sum }_{k = 0}^{n} {w}_{k} \vert \tilde{X} ( {r}_{k} f ) \vert$$

The normalizing constant C results, in this case, from the condition that the probability density integrated over the permissible frequency range of fᵢ to fᵤ assumes the value 1.

∫_{f}_{ᵢ}^{f}^{ᵤ}P(f)df=1

The main speed then results from the frequency at which the probability density P(f) becomes maximum. The relative frequencies and their weighting factors are established on the basis of the typically expected spectrum, wherein a test measurement can be optionally required if the information regarding the expected signal is initially insufficient.

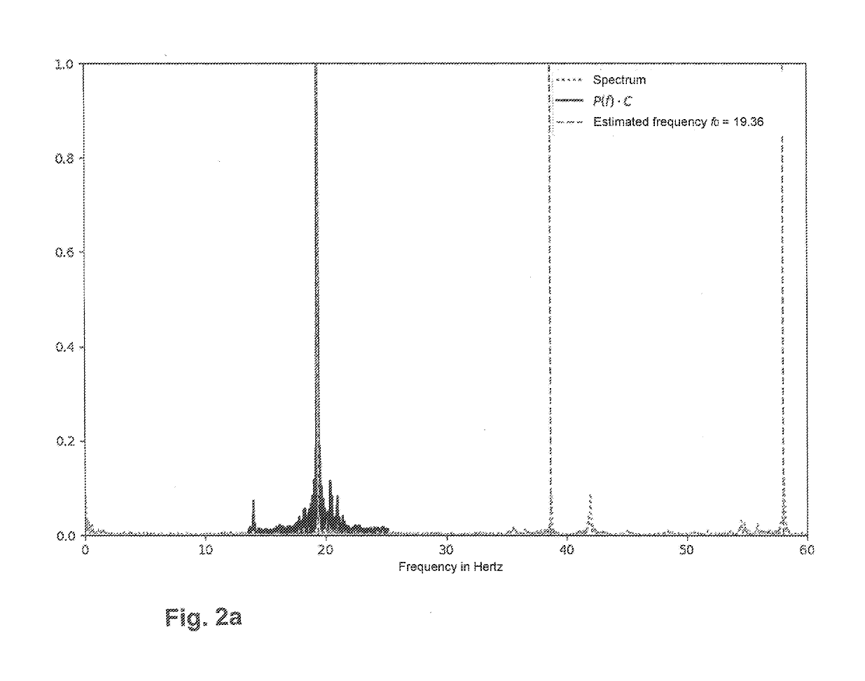

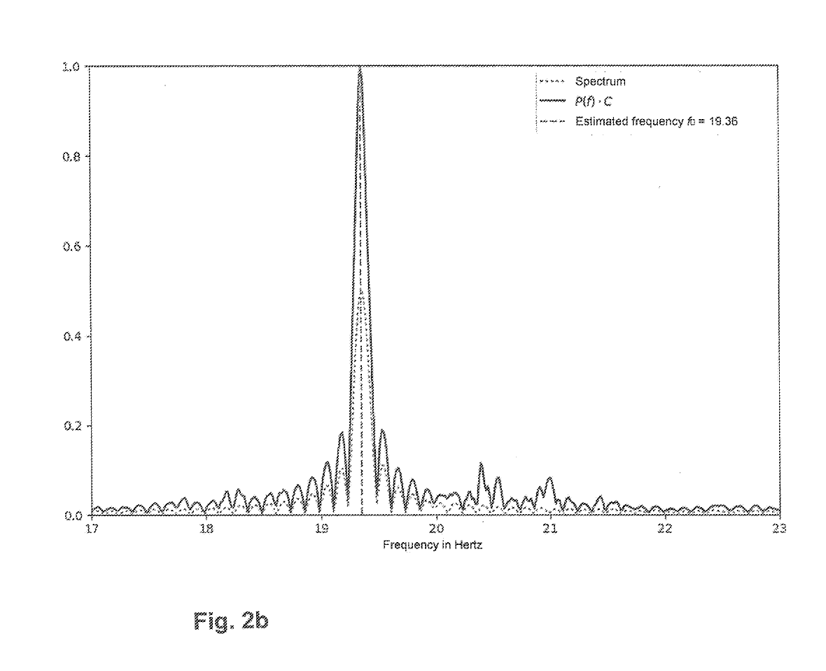

FIGS. 2a and 2b show one example for determining rotational speed utilizing the main frequency and the two first harmonics, each of which is weighted the same as the main frequency, wherein the spectrum is represented with the two harmonics in FIG. 2a and the enlarged spectrum is shown in an enlarged view in FIG. 2b in the range about the main frequency at approximately 18 Hz, together with the calculated probability density. The signal has been oversampled by a factor of 7 in this case.

In principle, the probability density can also be determined in a variable other than the measured variable, for example in speed instead of acceleration.

For cases in which multiple distinctive frequencies are present in the spectrum, the method described so far can be improved by iteratively carrying out the calculation of the probability density and the determination of the main speed on the basis of the maximum of the probability density, wherein the components of the most recently determined main speed and its relative frequencies are removed from the present spectrum, in order to produce a corrected spectrum which is then used as the basis for the next iteration, in which a new potential main speed is determined on the basis of the maximum of the new probability density which is calculated from the corrected spectrum. A probability that this is the sought machine speed is then calculated for each of the potential main speeds determined in this way.

The determination of the sought machine speed is based on the following assumptions: The sought frequency lies in a certain expected frequency range; and the probability that a potential main speed is the sought machine speed is that much greater, the higher the amplitude of this frequency is and the higher the amplitudes of the relative frequencies associated with this frequency are.

In such an iterative method, the probability density P(f) for the original spectrum is first determined, as in the example from FIG. 2, according to:

$$P ( f ) = \frac{1}{C} {\sum }_{n = 0}^{N} {w}_{n} \vert \tilde{X} ( {r}_{n} f ) \vert , f ∈ [ {f}_{l} , {f}_{h} ]$$

wherein r₀=1 and |\tilde{X}(f)| is the absolute value of the Fourier transform of the oversampled signal; the normalizing constant C does not need to be calculated for practical applications. The constants wₙ and rₙ are selected in this case based on known signals or test signals in such a way that the probability density P(f) becomes maximum at f₀.

Subsequent thereto, with respect to the found potential main speed f₀, the absolute values of the frequency components at rₙ*f₀ are removed from \tilde{X}=\tilde{X}₀, i.e., from the Fourier transform. In order to correctly take the effects of the windowing into account, the Fourier transform W_{A} of a time window w_{A} is required, wherein, for example, a discrete rectangular window having the length M having a sampling time T can be utilized as the time window:

$${w}_{A} ( k ) = \{ \begin{matrix}\frac{1}{MT} : & if 0 \leq k < M \\ 0 : & otherwise\end{matrix} .$$

The corrected spectrum \tilde{X}₁, from which the absolute values of the low frequency components with respect to the potential main frequency f₀ have been removed, can be determined as follows:

$${\tilde{X}}_{1} ( f ) = {\sum }_{n = 0}^{N} {\sum }_{f} ( {\tilde{X}}_{0} ( f ) - {\tilde{X}}_{0} ( {r}_{n} {f}_{0} ) \cdot {W}_{A} ( {r}_{n} {f}_{0} - f ) )$$

wherein the inner sum covers all discrete frequencies f. By way of \tilde{X}=\tilde{X}₁, a new probability density P₁(f) and, therefore, f₁, can now be determined. This method can be successively continued, wherein the i-th iteration step yields

$${\tilde{X}}_{i} ( f ) = {\sum }_{n = 0}^{N} {\sum }_{f} ( {\tilde{X}}_{i - 1} ( f ) - {\tilde{X}}_{i - 1} ( {r}_{n} {f}_{0} ) \cdot {W}_{A} ( {r}_{n} {f}_{0} - f ) ) , \\ {P}_{i} ( f ) = \frac{1}{C} {\sum }_{n = 0}^{N} {w}_{n} {\tilde{X}}_{i} ( {r}_{n} \cdot f ) , f ∈ [ {f}_{l} , {f}_{h} ] , \\ {f}_{i} = \{ f : {P}_{i} ( f ) = max {P}_{i} ( f ) \}$$

The normalizing constant C results for i=0 as described above and is identical for all Pᵢ.

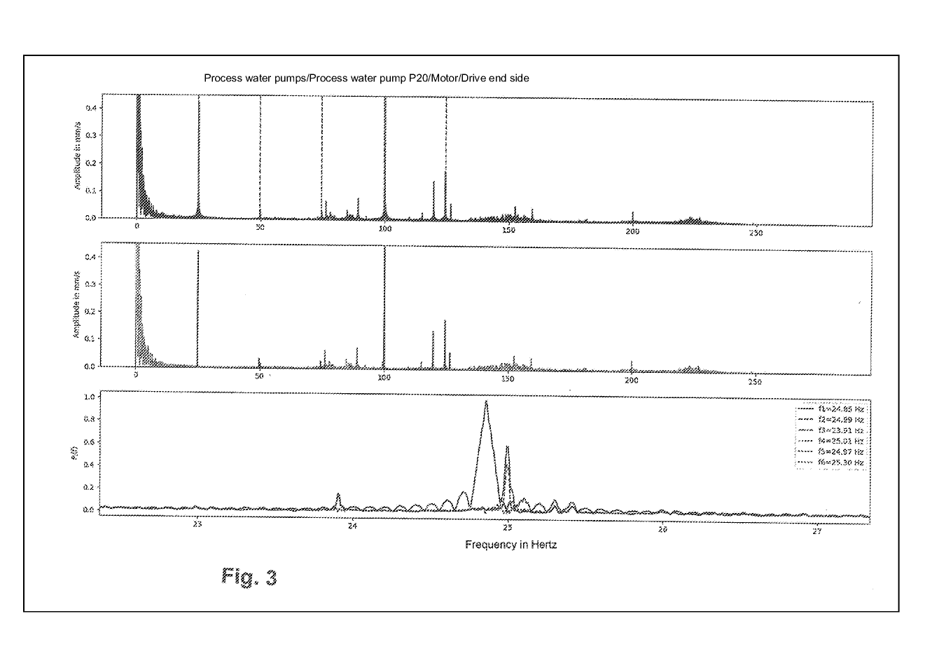

FIG. 3 shows one example of an iterative method, wherein the vibration spectrum shown at the top in FIG. 3 (in which the motor speed and its harmonic are plotted as vertical lines) has been subjected to six iterations in order to determine potential main speeds, wherein plotted in the middle of FIG. 3 is the corrected spectrum obtained after six iterations, together with the spectral lines removed from the original spectrum, and wherein the non-normalized probability densities Pᵢ(f) obtained in each iteration are shown at the bottom in FIG. 3. The particular main frequency and its first four harmonics were taken into account in the determination of the probability density, wherein the main frequency was weighted with the factor 1 and the four harmonics were weighted with a factor of 0.5. The frequency band for the sought frequency included the expected main frequency ±10%. The machine is the motor of a process water pump of a sewage treatment plant, wherein it is apparent from FIG. 3 that two frequencies located close to each other were found with a high probability density, namely the actual machine speed at 24.86 Hz and a slightly higher frequency at 24.99 Hz which corresponds to the electrical rotational frequency of the asynchronous motor.

The question arising with respect to the potential main frequencies found by the iterative method is which of these frequencies actually represents the sought machine speed. In order to answer this question, it is helpful to introduce a trust probability (or a normalized trust value) which assigns to the main frequency fᵢ belonging to the iteration i a probability that this is the sought machine speed.

Δpᵢ=pᵢ−pᵢ₊₁=∫_{f}Pᵢ(f)−Pᵢ₊₁(f)df

The assignment is based on the following considerations: The frequency fᵢ is that much more likely to be the sought frequency, the greater the difference of the cumulative probabilities/probability densities for the iteration i and the subsequent iteration i+1 is. The difference of the cumulative probabilities results in this case as the integral of the difference between the probability density for the present iteration and the probability density for the subsequent iteration over all permissible frequencies. This means, the more unambiguously the predefined pattern fits the signal, the greater the difference of the cumulative probabilities Δpᵢ is. If the difference Δpᵢ₊₁−Δpᵢ is equal to 0, however, this means the frequencies found in two consecutive subzones, for example, f₀ and f₁, fit the predefined pattern equally well and, therefore, both frequencies correspond to the sought frequency with the same probability. This is very often the case with asynchronous motors, for example, since, in this case, there is slip between the mechanical rotational frequency and the electrical rotational frequency. On the other hand, if Δp₀ is substantially greater than all Δpᵢ with i>0, it can be assumed that f₀ corresponds to the sought frequency.

If N iterations are carried out, i.e., if N potential main speeds are determined, the trust probabilities can be normalized as follows, in order to obtain a trust value t, with respect to the frequency fᵢ:

$${t}_{i} = \frac{{p}_{i} - {p}_{i + 1}}{{p}_{0} - {p}_{N + 1}}$$

Typically, a trust value of at least 70% can be assumed to be sufficiently great for a potential main frequency fᵢ. If one sets p_{N+2}=0, then this equation can also be used for determining t_{N+1}, which can be considered to be a measure of the noise of the signal. If tᵢ−p₊₁, the frequency fᵢ is not particularly distinguished from the background noise.

It would be appreciated by those skilled in the art that various changes and modifications can be made to the illustrated embodiments without departing from the spirit of the present invention. All such modifications and changes are intended to be covered by the appended claims.

What is claimed is:

1. A method for determining at least one speed of a machine, comprising the steps of:
on the basis of the measurement of a vibration variable carried out on the machine over time, determining the complex spectrum of this variable, wherein a frequency interpolation is carried out;
establishing boundary conditions for the evaluation of the spectrum, which include the permissible frequency range of an expected main speed, a set of relative frequencies with respect to the main speed where the relative frequencies are determined by frequency multipliers, and a weighting factor for every particular relative frequency;
calculating a spectral probability density with consideration for these boundary conditions, which results for each frequency of the permissible frequency range as a sum of the amplitude of the spectrum, which has been weighted with the particular weighting factor, at the frequency multiplied by the particular frequency multiplier; and
determining the main speed on the basis of the frequency having the maximum probability density.

2. The method according to claim 1, further comprising determining a set of potential main speeds by iteratively carrying out the calculation of the probability density and the determination of the main speed on the basis of the maximum of the probability density by removing from the present spectrum the components of the most recently determined main speed and its relative frequencies, in order to produce a corrected spectrum which is used as the basis for the next iteration, in which a new potential main speed is determined on the basis of the maximum of a new probability density which is calculated on the basis of the corrected spectrum with consideration for the boundary conditions.

3. The method according to claim 2, wherein the components of the most recently determined main speed and its relative frequencies are removed, these components are multiplied by the Fourier transform of a temporal window function, in order to at least partially avoid windowing effects in the corrected spectrum.

4. The method according to claim 2, wherein each of the determined potential main speeds, a trust probability is determined that this is the sought machine speed.

5. The method according to claim 4, wherein the trust probability of a potential main speed results from the difference, which has been integrated over all frequencies of the permissible frequency range, of the probability density utilized in the determination of the particular potential main speed and the probability density utilized in the next iteration.

6. The method according to claim 5, wherein a trust value is provided for each of the determined potential main speeds, which results from the particular trust probability, divided by the difference, which has been integrated over all frequencies of the permissible frequency range, between the probability density utilized in the first iteration and the probability density calculated on the basis of the corrected spectrum obtained in the last iteration.

7. The method according to claim 6, wherein a trust value of at least 70% is required in order to accept the determination of the particular main speed as the machine speed.

8. The method according claim 1, wherein the relative frequencies are higher harmonics of the main speed, wherein the frequency multipliers are natural numbers.

9. The method according to claim 8, wherein the first five higher harmonics are taken into consideration.

10. The method according to claim 1, wherein the spectrum is determined by oversampling in the frequency range.

11. The method according to claim 10, wherein the oversampling in the frequency range takes place via augmentation with zeros in the time signal and a subsequent Fourier transform.

12. The method according to claim 10, wherein the oversampling is at least eight-fold.

13. The method according to claim 1, wherein the boundary conditions are selected on the basis of an expected spectrum or on the basis of an empirically determined test signal.

14. The method according to claim 1, wherein the vibration measurement variable is a deflection, a speed, or an acceleration.

15. A system for determining at least one speed of a machine (10), comprising:
a sensor for measuring a vibration variable on a machine over time and an evaluation device which is configured and arranged for:
determining a spectral distribution on the basis of the measurement of the vibration variable, including a frequency interpolation;
calculating a spectral probability density with consideration for boundary conditions which include the permissible frequency range of the expected main speed, a set of relative frequencies with respect to the main speed, and a weighting factor for every particular relative frequency, wherein the relative frequencies are determined by frequency multipliers wherein the spectral probability density results for each frequency of the permissible frequency range as a sum of the amplitude of the spectrum, which has been weighted with the particular weighting factor, at the frequency multiplied by the particular frequency multiplier; and
determining the main speed on the basis of the frequency having the maximum probability density.
